(19) United States
(12) Patent Application Publication
(10) Pub. No.: US 2007/0013480 A1
(43) Pub. Date: Jan. 18, 2007

(54) Containerized inventory management system utilizing identification tags

(76) Inventors: Allen B. Kantrowitz, Williamstown, MA (US); In K. Mun, Nanuet, NY (US)

Correspondence Address: GIFFORD, KRASS, GROH, SPRINKLE & CITKOWSKI, P.C, PO BOX 7021, TROY, MI, 48007-7021, US

(21) Appl. No.: 11/441,309

(22) Filed: May 25, 2006

Related U.S. Application Data
(60) Provisional application No. 60/684,276, filed on May 25, 2005.

(51) Int. Cl. G05B 19/00

(52) U.S. Cl. 340/5.92

(57) ABSTRACT

An inventory control process includes the association of an inventory item with a reusable container at an origination point. The container is inclusive of a passive or active identification tag. The container is transported within the range of a transponder able to share information with the identification tag. Upon reaching a destination point, the inventory item is unpacked from the container and the container recycled for association with a new inventory item. An inventory delivery device includes a reusable container labeled with an active identification tag. An inventory item is inserted within the container. A disposable tamper-evident seal retaining the inventory item with the container is provided. The device is particularly well suited for transportation for timely and high clinical value items within a medical care setting.

### RELATED APPLICATION

This application claims priority of United States Provisional Patent Application Ser. No. 60/684,276 filed May 25, 2005, which is incorporated herein by reference.

### FIELD OF THE INVENTION

The present invention in general relates to the tracking of articles within an organization and in particular to a process for affixing an identifying label to a container and inventory associated with the container.

### BACKGROUND OF THE INVENTION

Radiofrequency identification (RFID) tags are broadly classed as to passive and active tags. While a passive tag lacks a power supply in electrical communication with the tag, an active identification tag has a coupled power supply and actively broadcasts a signal. Generally, a passive tag tends to be less expensive, more compact and has a longer operating lifetime than a comparable active tag, at the expense of requiring more complex tag interrogation systems. An impediment to the use of RFID tags in inventory management systems is the initial effort associated with individual inventory items and the comparative cost of tags relative to inventory items. While the cost of passive identification tags is generally comparatively lower than that of active tags, the cost of the tag and labor associated with affixing such tags remains considerable.

Thus, there exists a need for an inventory management system that provides for the efficient reuse of identification tags while avoiding the need to affix an individual tag to each inventory item or lot.

### SUMMARY OF THE INVENTION

An inventory control process includes the association of an inventory item with a reusable container at an origination point. The container is inclusive of a passive or active identification tag. The container is transported within the range of a transponder able to share information with the identification tag. Upon reaching a destination point, the inventory item is unpacked from the container and the container recycled for association with a new inventory item.

An inventory delivery device includes a reusable, container labeled with an active identification tag. An inventory item is inserted within the container. A disposable tamper-evident seal retaining the inventory item with the container is provided. The device is particularly well suited for transportation for timely and high clinical value items within a medical care setting.

### BRIEF DESCRIPTION OF THE DRAWING

FIG. 1 is a schematic diagram of the steps involved in practicing the present invention; and

FIG. 2 is a partial cutaway view of an inventive recyclable tagged container.

### DETAILED DESCRIPTION OF THE PREFERRED EMBODIMENTS

The present invention has utility as an inventory management system that efficiently reuses identification tags and limits handling associated with tag affixation. These improvements are achieved by affixing a radiofrequency identification (RFID) or optical identification tag as detailed in pending patent application Ser. No. 11/056,808 onto a reusable bin or container. It is appreciated that dimensions, construction materials and shape are largely dictated by the particulars of the inventory items to be handled. The items entered into a tagged container are noted by a conventional technique such as manual recordation or barcode scanning. The items are then associated with the identification tag. As the inventory associated container moves through an organization, the location of the container and therefore the associated contents are noted.

The present invention is particularly well suited for inventory management in complex organizational settings with individualized and small lot delivery of goods. Organizations well suited to benefit from the present invention illustratively include hospitals and customized manufacturing facilities. The tracking of high clinical value materials or time-sensitive materials in a medical setting is of particular concern. Such materials illustratively include medications, blood or tissue samples, radioactive reagents, and medical procedure kits.

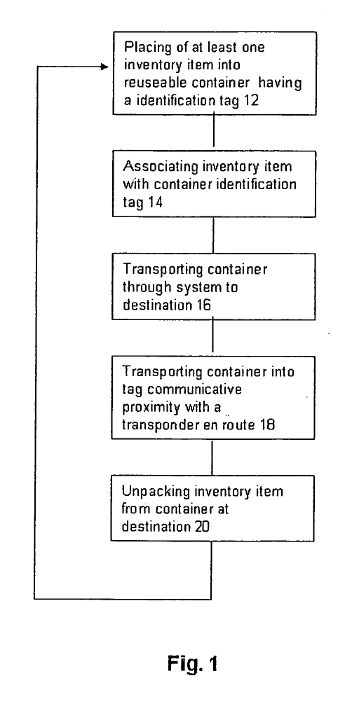

Referring now to FIG. 1, an inventive process is disclosed generally at 10. The placing of at least one inventory item in connection with a container having an identification tag 12 includes associating each inventory item with a respective container tag 14. The association is readily performed by manual data entry onto paper or a computer, or preferably through the use of optical or magnetic barcode reading. After associating inventory items with a container identification tag 14, the container is transmitted through the supply system 16.

Preferably, the tag 14 is an active tag. An active tag is more preferably rechargeable. Recharging is readily performed by exposing a tag ultra capacitor to the electrical field associated with a recharging coil. Alternatively, a passive tag is interrogated by a proximal reader encountered at a transit terminus or in transit.

During transportation of the container, it is brought within communicative proximity to a transponder 18 so as to provide near real-time tracking of the container en route and identification of transportation bottlenecks within the system. It is appreciated that the nature of the transponder operative herein is dependent on whether the identification tag is radiofrequency or optical, active or passive. At the end of container transport, the container arrives at the destination where the individual inventory items associated with the container are unpacked and the container recycled for another delivery 20. Container integrity in the course of transport is maintained by securing the container with a tamper-resistant seal to prevent inventory pilfering and/or loss en route.

It is appreciated that delivery time scheduling is readily performed such that containers arrive at the time of need, thereby decreasing the distributed inventory of inventory items stocked in wards, surgical suites, or treatment settings. Further, containers are readily prioritized within a delivery system. The performance of active checks of timetable delivery scheduling is performed to assess container flow. A check typically involves detection of all containers within the delivery system at a particular time. Periodic delivery checks are used as input data to a neural network routing program to efficiently utilize delivery bandwidth.

The inventive system is particularly well suited for use with a pressurized tube delivery system. Use of the inventive system in conjunction with a tube delivery system in a preferred embodiment utilizes a neural network routing controller that is self-learning in assembling optimal routes between source and destination for a particular container. Self-learning route control programs and the underlying methodologies are conventional to the art.

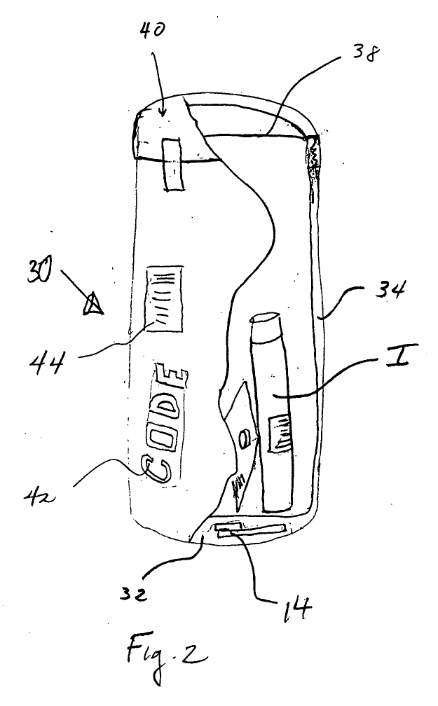

Referring to FIG. 2, an inventive container is shown generally at 30 where the container tag 14 is as described with respect to FIG. 1. The container 30 has a bottom 32 and a sidewall 34 defining a container volume 36. The volume 36 is adapted to receive an inventory item I such as those having a barcode. The sidewall 34 terminates in a mouth 38 engaging a cap 40. The cap 40 is secured to the mouth 38 by conventional means including complementary threads, press fit features, and a swivel mount. The tamper-evident or tamper-resistant seal 42 spans the interface between the cap 40 and sidewall 34. A high tack adhesive tape is well suited to function as a seal 40. The container tag 14 is secured into the container bottom 32 or sidewall 34. A tag 14 is readily potted with a curable resin to permanently adhere the tag 14 in place. Alternatively, a tag is adhered to a container surface with an adhesive tape or molded into the container. It is also appreciated that a tag 14 is associated with a swivel attached cap permanently attached to the container. Human cognizable coding 42 and/or bar coding 44 are optionally affixed to a container 30 allowing for integration with other coding and inventory handling systems.

The foregoing description is illustrative of particular embodiments of the invention, but is not meant to be a limitation upon the practice thereof. The following claims, including all equivalents thereof, are intended to define the scope of the invention.

1. An inventory control process comprising:
associating at least one inventory item with a reusable container at an origination point comprising a passive or active identification tag;
transporting said container into a communicative range with at least one transponder able to share information with said identification tag;
unpacking said at least one inventory item from said container at a destination point; and
recycling said container to be associated with a new inventory item.

2. The process of claim 1 wherein association is performed by optical or magnetic scanning of said at least one inventory item and associating the scanned data with said identification tag.

3. The process of claim 1 wherein said identification tag is a radiofrequency identification tag.

4. The process of claim 3 wherein said radiofrequency identification tag is active.

5. The process of claim 4 further comprising recharging said radiofrequency identification tag.

6. The process of claim 1 wherein said identification tag is an optical identification tag.

7. The process of claim 1 wherein transporting said container occurs through a portion of pressurized air tube.

8. The process of claim 7 wherein said pressurized air tube is found within a hospital.

9. The process of claim 1 further comprising applying a tamper-evident seal to said container prior to transportation thereof.

10. The process of claim 1 further comprising identifying an optimal route for transportation of said container with a self-learning route controller program operating on a computer.

11. The process of claim 10 wherein said route controller program is a neural network.

12. The process of claim 1 further comprising checking timetable delivery scheduling during the transporting of said container.

13. An inventory delivery device comprising:
a reusable container labeled with an active identification tag;
an inventory item within said container; and
a disposable tamper-evident seal retaining said inventory item in association with said container.
